(19) United States
(12) Patent Application Publication
(10) Pub. No.: US 2003/0131088 A1
(43) Pub. Date: Jul. 10, 2003

(54) Method and system for automatic selection of a test system in a network environment

(75) Inventors: Christopher M. Morrissey, Round Rock, TX (US); Xiaoping Chen, Austin, TX (US)

Correspondence Address: Frank C. Nicholas, CARDINAL LAW GROUP, Suite 2000, 1603 Orrington Avenue, Evanston, IL, 60201, US

(73) Assignee: IBM Corporation

(21) Appl. No.: 10/045,321

(22) Filed: Jan. 10, 2002

(51) Int. Cl. G06F 15/173

(52) U.S. Cl. 709/223

(57) ABSTRACT

Computer program product and systems using the method are also provided.

### BACKGROUND OF THE INVENTION

1. Field of the Invention

The present invention relates to client devices in a distributed network environment and, in particular, client devices that may be used to test distributed software. More specifically, the present invention relates to a method for automatically selecting the appropriate existing test system for a given distributed software test.

2. Description of Related Art

Distributed software may sometimes require testing on a test client system within a distributed environment. Because a distributed environment is heterogeneous, i.e., includes several different types of test systems, the test case may only be run on chosen test systems which fit a certain criteria. Moreover, because the success of a test may best be evaluated within an actual network environment, the test may best be run on a “test system”, which is a system actually running in the distributed environment.

Each test system will have different characteristics and behaviors, such as a different operating system, different memory resources, different hardware resources and different software applications already running on the system. For example, a first test system in the distributed environment may be two client devices, both of which use the OS/2 Warp 4 operating system, both of which have CD-ROM drives and both of which run the same suite of software applications. Meanwhile, a second test system in the same distributed environment may be a first client device using a Windows 2000™ operating system and a second client device using a Windows 98™ operating system, even though the two devices also run the same suite of software applications.

Typically, most testing scenarios require human intervention for matching the test criteria to an appropriate test system to find the best match. That is, a user looks at the system requirements for the software to be tested and searches for the test system in the distributed network that has these system requirements.

This manual step to selecting a test system may become a bottleneck in the process of testing automation.

It would be desirable therefore to provide a method of selecting a testing system that overcomes the above.

### SUMMARY OF THE INVENTION

One aspect of the invention provides a method of selecting a test system in a distributed network environment. A target test system description, which is associated with a software test, is determined at a management server. The target test system description is compared at the management server to a list of test system descriptions. A test system description from the test system descriptions list is selected that matches the target test system description. The selected test system description is associated with a particular test system that is then selected.

The management server may receive the software test associated with the target test system description. The management server may also forward the software test, to the selected test system and execute software test at the selected test system. In addition, the management server may receive a test system description, the test system description associated with a functioning system in the distributed network environment. This test system description may be compared to the test system descriptions list. This test system description may further be added to the test system descriptions list.

A management agent may also communicate with the functioning system and determine at least one characteristic of the functioning system at the management agent in order to create the test system description based on the at least one characteristic. The test system descriptions list may comprise, for example, descriptions of fully functioning test systems, descriptions of heterogeneous test systems, descriptions of test systems used to balance a network workload, descriptions of test systems used during specific usage periods, and descriptions of test systems compatible with a particular test.

Another aspect of the present invention provides computer program product in a computer usable medium for selecting a test system in a distributed network environment. The product comprises means for determining a target test system description associated with a software test, at a management server; means for comparing the target test system description to a test system descriptions list at the management server; means for selecting a test system description from the test system descriptions list that matches the target test system description; and means for contacting a selected test system which is associated with the selected test system description.

Yet another aspect of the present invention provides a system for selecting a test system in a distributed network environment. The system of the present invention comprises means for determining a target test system description associated with a software test, at a management server; means for comparing, at the management server, the target test system description to a test system descriptions list; means for selecting a test system description from the test system descriptions list that matches the target test system description; and means for contacting a selected test system which is associated with the selected test system description.

In some embodiments of the invention, the program and system of the present invention may further include means for receiving, at the management server, the software test associated with the target test system description. The program and system of the present invention may also include means for forwarding, from the management server, the software test, to the selected test system as well as means for executing the software test at the selected test system. In addition, the program and system of the present invention may include means for receiving at the management server, a test system description, the test system description associated with a functioning system in the distributed network environment. The program and system of the present invention may also include means for comparing the test system description to the test system descriptions list as well as means for adding the test system description to the test system descriptions list. Means for communicating with the functioning system at a management agent, means for determining at least one characteristic of the functioning system at the management agent and means for creating the test system description based on the at least one characteristic may also be provided in accordance with the present invention.

The foregoing, and other, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims in equivalence thereof.

### BRIEF DESCRIPTION OF THE DRAWINGS

FIG. 1 is a schematic diagram of one embodiment of a network of data processing systems in accordance with the present invention;

FIG. 2 is a block diagram of one embodiment of a data processing system in accordance with the present invention;

FIG. 3 is a block diagram of another embodiment of a data processing system in accordance with the present invention;

FIG. 4 is a flow diagram of one embodiment of a method of selecting a test system in accordance with the present invention;

FIG. 5 is a flow diagram of one embodiment of a method of selecting a test system continuing the embodiment of FIG. 4; and

FIG. 6 is a flow diagram of one embodiment of a method of updating a test system in accordance with the present invention.

### DETAILED DESCRIPTION OF THE PRESENTLY PREFERRED EMBODIMENTS

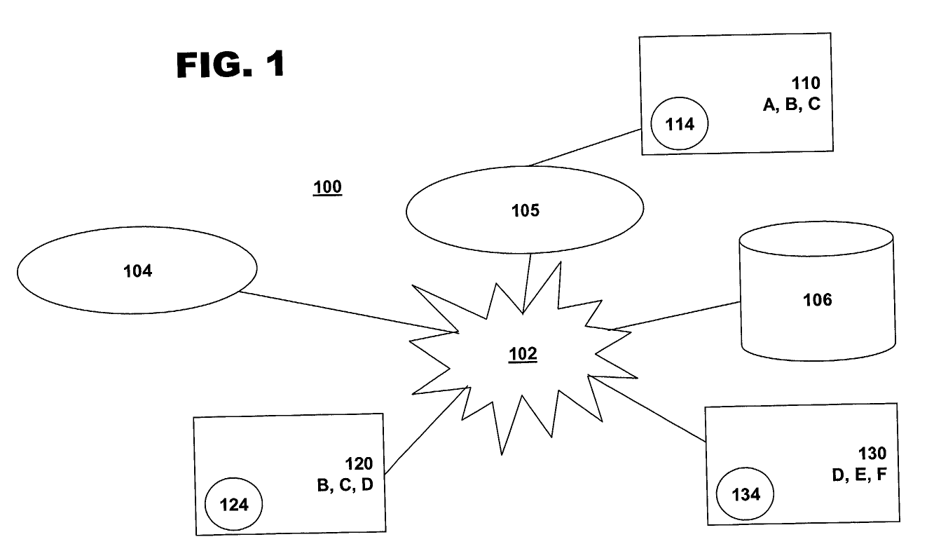

FIG. 1 is a schematic representation of a network of data processing systems in accordance with the present invention at 100. Network data processing system 100 may be a network of computers in which the present invention may be implemented. Network data processing system 100 may contain a network 102. Network 102 may be any suitable medium used to provide communications links between various devices and computers connected to or in communication with each other within network data processing system 100. For example, network 102 may include connections, such as wire connections, wireless communication links or fiber optic cables.

In the embodiment of FIG. 1, a server 104 may be in communication with network 102. Server 104 may provide data, such as boot files, operating system images and applications to network 102 and/or to other components in communication with network 102 as described below.

System 100 may also include another server 105 which may be identical to or different from server 104. Server 105 may also provide data, such as boot files, operating system images and applications to network 102 and/or to other components in communication with network 102 as described below. In one embodiment of the invention, server 105 may be a management server as described further below. Management server 105 may provide data such as operating system data, test system data, memory resources, hardware resources, software applications and test application to network 102 and/or to other components in communication with network 102 as described below. System 100 may also include additional servers (not shown).

One or more storage units, such as storage unit 106 may also be in communication with server 104, 105 and/or network 102. Storage unit 106 may store data, such as boot files, operating system images and applications that may be processed or conveyed by server 104, 105. Storage unit 106 may also store data to be made available to or process by network 102 and/or to other components in communication with network 102 as described below. In one embodiment of the invention, storage unit 106 may store data regarding existing test systems in communication with network 102.

One or more management agents 114, 124, 134 may also be in communication with network 102. These management agents may be, for example, a test management program running on a specific test system. These management agents may be, for example, test management software running on a personal computer or a network computer. These management agents may also be, for example, test management software running on servers that are similar or different from servers 104, 105. In one embodiment of the invention, management agents 114, 124, 134 may be in communication with server 105. In one embodiment of the invention, each management agent may be located on a specific test subsystem of network 102. For example, the embodiment of FIG. 1 shows three subsystems 110, 120, 130. Each of these subsystems has its own management agent in communication with network 102. Management agent 114 resides on subsystem 110. Management agent 124 resides on subsystem 120. Management agent 134 resides on subsystem 130. Network data processing system 100 may include additional management agents and subsystems not shown. Additionally, each subsystem may include additional management agents and target devices not shown.

Test subsystems 110, 120, 130 may also be in communication with network 102. These test subsystems may be, for example, personal computers or network computers, test subsystems 110, 120, 130 may serve as clients to server 104. Additionally, a given test subsystem may be associated with a particular management agent. For example, test subsystem 110 is associated with management agent 114. Network data processing system 100 may include additional servers, clients and other devices not shown.

Subsystems 110, 120, 130 may comprise clients, servers and agents that are actually functioning as clients, servers and agents of network 102. Alternatively, subsystems 110, 120, 130 may comprise clients, servers and agents that simulate certain client, server and/or agent functions of network 102. Thus, subsystems 110, 120, 130 may comprise actual working components of network 102 or may comprise components specifically used for running tests, such as software tests. In one embodiment of the invention, management server 105 may track information about one or more of subsystems 110, 120, 130.

As seen in FIG. 1, network data processing system 100 may be any suitable system of processing data. For example system 100 may be the Internet. Alternatively, network data processing system 100 may also be any suitable type of network such as, for example, an intranet, a local area network (LAN) or a wide area network (WAN). In one embodiment of the invention, network 102 represents a worldwide collection of networks and gateways that use the TCP/IP suite of protocols to communicate with one another. A backbone of high-speed data communication lines between major nodes or host computers allows communication between thousands of commercial, government, educational and other computer systems that route data and messages.

One embodiment of the present invention provides a network environment, which may include a management server. For example, server 104 may be a management server. Alternatively, as seen in FIG. 1, server 105 may be a management server. In one embodiment of the invention, one or more target devices, such as test subsystems 110, 120, 130 may have the ability to communicate with management server 105. For example, test subsystems 110, 120, 130 may be able to receive test software and/or test instructions from management server 105. Alternatively, one or more management agents 114, 124, 134 may have the ability to communicate with management server 105. For example, test subsystems 110, 120, 130 may be able to receive test software and/or test instructions from management server 105 via their respective management agents.

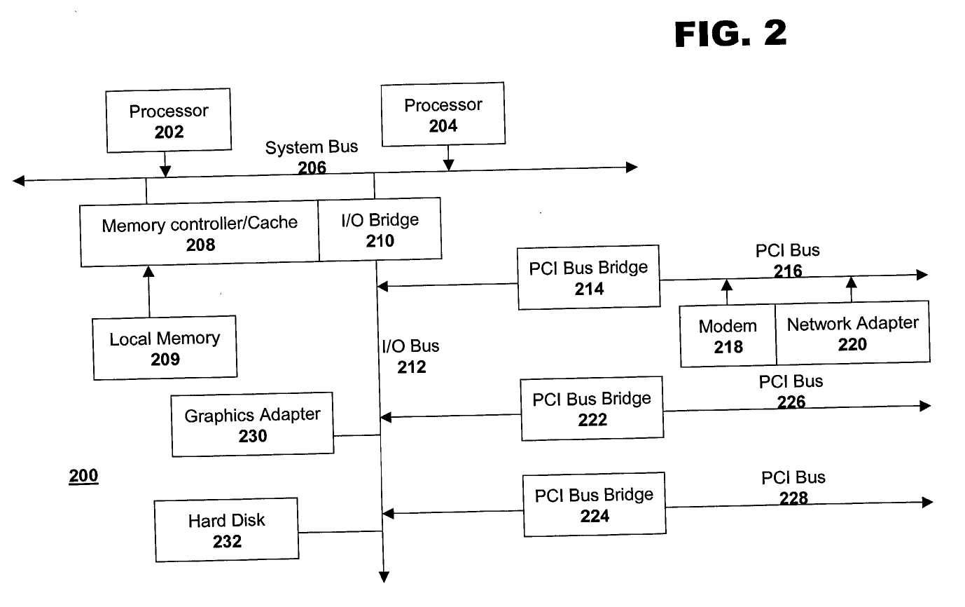

FIG. 2 is a block diagram of a data processing system in accordance with the present invention at 200. In one embodiment of the invention, data processing system 200 may be implemented as one or more of the servers 104, 105 shown in FIG. 1. Alternatively, data processing system 200 may implement test management software, such as one or more of the management agents 114, 124, 134 shown in FIG. 1.

Data processing system 200 may be a symmetric multiprocessors (SMP) system including a plurality of processors 202 and 204 connected to system bus 206. Alternatively, a single processor system may be employed. Memory controller/cache 208 may also be connected to system bus 206. Memory controller/cache 208 may provide an interface to local memory 209. I/O bus bridge 210 may also be connected to system bus 206 and may provide an interface to I/O bus 212. Memory controller/cache 208 and I/O bus bridge 210 may be integrated as depicted or may be separate components.

Peripheral component interconnect (PCI) bus bridge 214 connected to I/O bus 212 may provide an interface to PCI local bus 216. One or more modems may be connected to PCI bus 216. Typical PCI bus implementations will support four PCI expansion slots or add-in connectors. Modem 218 and network 220 may be connected to PCI local bus 216. This connection may be through add-in boards. In one embodiment of the invention, modem 218 and accompanying connections provide communications links to target devices such as network computers. For example, such target devices may be those described above at FIG. 1.

Additional PCI bus bridges 222 and 224 may provide interfaces for additional PCI buses 226 and 228. Additional modems or network adapters may be supported from PCI buses 226 and 228. In this manner, data processing system 200 may allow connections to multiple network computers. A memory-mapped graphics adapter 230 and hard disk 232 may also be connected to I/O bus 212 as depicted, either directly or indirectly.

The components depicted in FIG. 2 may be arranged as shown or in any suitable manner that allows data processing system 200 to function as desired. Additionally, other peripheral devices, such as optical disk drives and the like, may be used in addition to or in place of the components depicted.

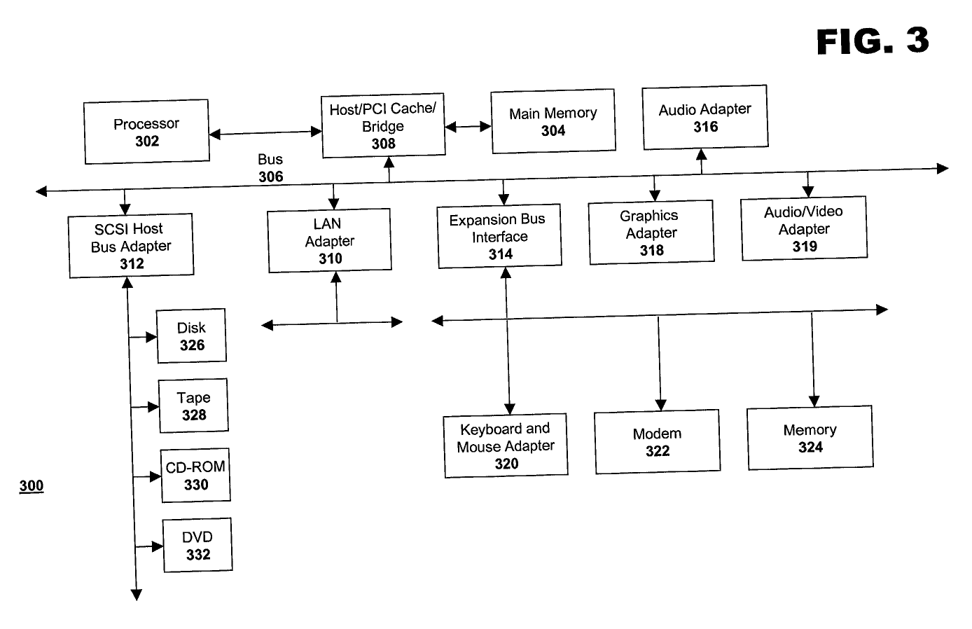

FIG. 3 is a block diagram of a data processing system in accordance with the present invention at 300. Data processing system 300 may be, for example, one or more of the test subsystems 110, 120, 130 depicted in FIG. 1 and described above. Data processing system may also comprise test management software, such as one or more of the management agents 114, 124, 134 depicted in FIG. 1 and described above.

In one embodiment of the invention, data processing system 300 may be a stand-alone system configured to be bootable without relying on a network communication interface. Alternatively, data processing system 300 may also comprise one or more network communication interfaces. Data processing system 300 may also be a personal digital assistant (PDA) device. Data processing system may also take the form of a notebook computer or handheld computer. Alternatively, data processing system 300 may be a kiosk or Web appliance. The processes of the present invention may also be applied to a multiprocessor data processing system.

Data processing system 300 may employ a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 may be connected to PCI local bus 306 via PCI bridge 308. PCI bridge 308 may also include an integrated memory controller and cache memory for processor 302. Additional connections to PCI local bus 306 may be made through direct component interconnection or through add-in boards. In one embodiment of the invention, local area network (LAN) adapter 310, SCSI host bus adapter 312, and expansion bus interface 314 are connected to PCI local bus 306 by direct component connection. In contrast, audio adapter 316, graphics adapter 318 and audio/video adapter 319 are connected to PCI local bus 306 by add-in boards inserted into expansion slots. Expansion bus interface 314 may provide a connection for additional components such as, for example, a keyboard and mouse adapter 320, a modem 322 and additional memory 324. A small computer system interface (SCSI) host bus adapter 312 may provide a connection for additional components such as, for example, a hard disk drive 326, a tape drive 328, a CD-ROM drive 330 or a DVD 332. PCI local bus 306 may be any suitable local bus implementation. Typical PCI local bus implementations will support three or four PCI expansion slots or add-in connectors.

In one embodiment of the invention, a software program or application for selecting and managing test systems may run on processor 302. This software program may comprise, for example, a management agent 114, 124, 134. This management agent may be used to coordinate and provide control of various test systems within network 102. Instructions for the management agent may be located on storage devices such as, for example, hard disk drive 326. These instructions, applications and/or programs may be loaded into main memory 304 for execution by processor 302.

The components of system 300 depicted in FIG. 3 may be arranged as shown or in any suitable manner that allows data processing system 300 to function as desired. Other internal hardware or peripheral devices, such as flash ROM (or equivalent nonvolatile memory) or optical disk drives and the like, may be used in addition to or in place of the components depicted. For example, one embodiment of data processing system 300 may be configured with ROM and/or flash ROM in order to provide non-volatile memory for storing operating system files and/or user-generated data.

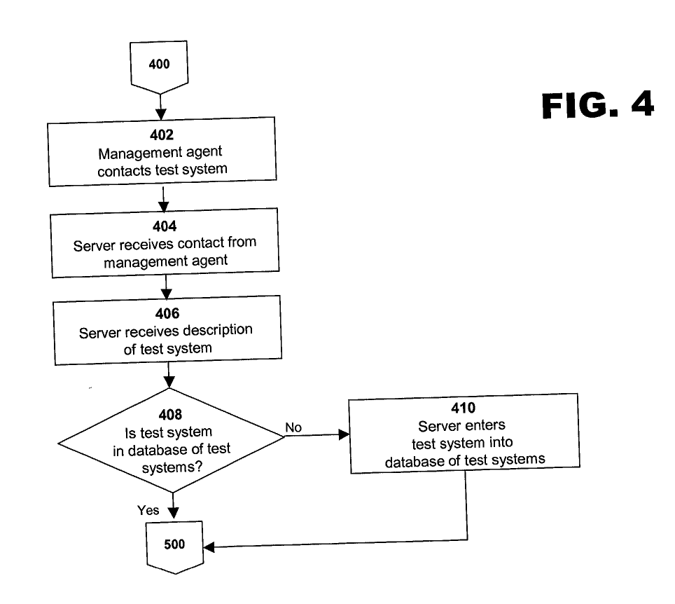

FIG. 4 shows a flow diagram of one embodiment of a method for selecting a test system in accordance with the present invention at 400. The test system selected using this method may be a system comprising one or more subsystems 110, 120, 130 and/or one or more management agents, 114, 124, 134 as depicted in FIG. 1 and described above. In one embodiment of the invention, the method of FIG. 4 is administered by a software program or application on or in association with the management server 105.

As seen at block 402, a management agent contacts a system that may be used as a test system. In one embodiment of the invention, the test system is a system that is currently operating or running. In one embodiment of the invention, the test system is running and the management agent begins contact by coming on line, e.g., the management agent is started by a user or the management agent is turned on when one or more components of the running system boot up. For example, in subsystem 110, management agent 114 may be started manually by a user. Alternatively, management agent 114 may be started when one or more components of subsystem 110 are running. In another embodiment of the invention, the system is running, including the management agent. The management agent then begins contact with the server after receiving a command, for example, from a user.

As seen at block 404, the management server receives contact from one or more management agents. For example, in the embodiment shown in FIG. 1, the management server 105 may be contacted by management agent 114, management 124, and/or management agent 134. In one embodiment of the invention, the management agent contacts the management server with a description of the system with which the agent is associated as described below at block 406.

As seen at block 406, once contact with the management server has been established, the management agent may describe to the management server 105 the characteristics of the system with which the agent is associated. For example, management agent 114 may describe to the management server 105 the characteristics of subsystem 110 (e.g., “test subsystem 110 is a target device with characteristics A, B, C”.) Meanwhile, management agent 124 may describe the characteristics of subsystem 120 (e.g., “test subsystem 120 is a target device with characteristics B, C, D”.) Management server 105 may also be contacted by management agent 134 which describes the characteristics of subsystem 130 (e.g. “test system 130 is a target device with characteristics D, E, F.”)

These test characteristics may include, for example, the operating system running on a given test system, memory resources of the system, hardware resources of the system and software applications running on the system. The test characteristics may be based on the requirements of the software test. For example, a software test may require a particular operating system and may not be compatible with other operating systems. Alternatively, a software test may require a certain amount of memory in order to run and will not be able to run on systems with less memory. Alternatively, a software test may require certain hardware in order to run and cannot use a test system that does not have this hardware. A software test may also require certain software applications to be installed already on a test system and will not be able to conduct its test on systems which do not have the software applications installed. In another instance, a software test may require a test system with a particular CPU load. Alternatively, a software test may require a test system with particular network settings (for example, a test system with multiple network cards or a multi-homed network system.)

In one embodiment of the invention, one characteristic provided to the management server 105 may be a workload characteristic. This characteristic may describe the current workload of a given system for load balancing purposes. For example, test system 110 and test system 120 both have characteristics B, C but, at the time of a particular test requiring B, C, test system 110 is busier or has a heavier workload than test system 120. Management server 105 may therefore, run the test initially on test system 120 and then on test system 110. Thus, if several test systems match the system requirements, load balancing could be achieved by spreading the testing components over several test systems. Moreover, if the test is performance-based, multiple copies of the same test may be sent to different test systems to conduct the test. Using the above example, if the test system requirements are for a test system that has characteristics B, C on all target devices in the system, then both test system 110 and test system 120 are matching systems. For a performance-based test, a copy of the test may be sent to system 110 and another copy to system 120 and the test evaluation may include comparing the performance of the test in system 110 to the performance of the test in system 120.

In one embodiment of the invention, the type of software test may determine the types of characteristics, which will be used to find a test system. For example, the software test may be a compatibility software test and the test characteristics will be used to determine whether the software test is compatible with test systems. Alternatively, the software test may be a performance-based test as described above and the test characteristics will be used to determine how the software test performs with various test systems.

Once an agent has contacted the management server and provided the information, the management agent may wait for further communication from the management server 105.

As seen at block 408, the management server may then determine if the test system described by a particular management agent is already entered in a database of systems associated with the management server 105. For example, as described above, the database of systems may be stored in storage unit 106 as described above.

As seen at block 410, if the test system described is not entered into the database of systems, the management agent may then add the test system and its characteristics into the database. Thus, over time, the management server may build a database comprising several test systems, all of which may be available to network 102 for testing distributed software. Some or all of these systems 110, 120, 130 may be fully functioning systems that are equipped to conduct the business of the network 102. Alternatively, some of the systems 110, 120, 130 may be available only for testing purposes. The database of systems may be a heterogeneous collection of test systems, i.e., the descriptions of various test systems may correspond in some cases and may differ in other cases. Some of the test systems may be systems that test performance, as described above, as well as software. Some of the test systems may run load-balancing software and may be used for testing during low usage periods.

Table 1 below shows one example of how the test systems depicted in FIG. 1 may be categorized in a database of systems.

TABLE 1

| | FIRST | SECOND | THIRD |
|---|---|---|---|
| | CHARACTER- | CHARACTER- | CHARACTER- |
| SYSTEM | ISTIC | ISTIC | ISTIC |
| 110 | A | B | C |
| 120 | D | B | C |
| 130 | D | E | F |

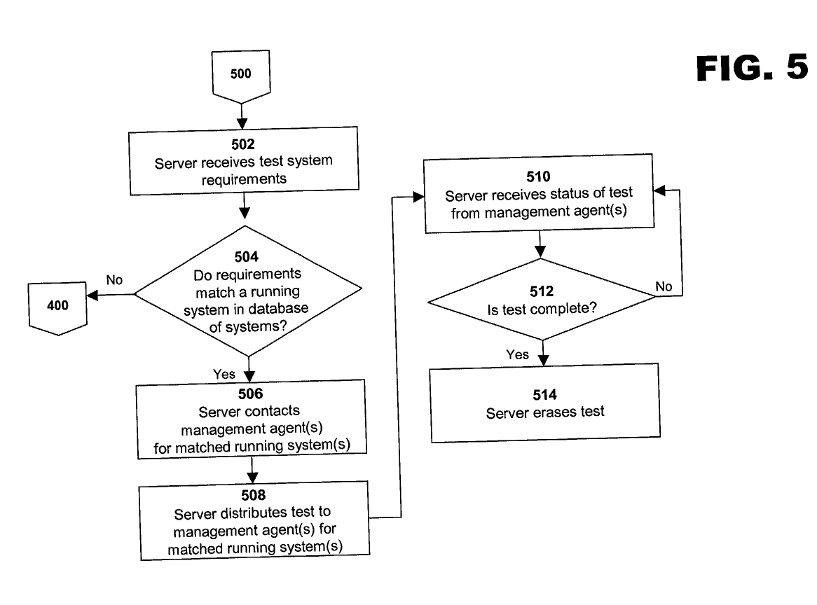

FIG. 5 shows a flow diagram of one embodiment of a subroutine in a method for selecting a test system in accordance with the present invention at 500. The test system selected using this method may be a system comprising one or more target devices and/or one or more management agents, such as subsystem 110, 120, 130 depicted in FIG. 1 and described above. In one embodiment of the invention, the method of FIG. 4 is administered by a software program or application on or in association with the management server 105.

The subroutine of FIG. 5 may take place after the method of FIG. 4 has begun within a particular network. Alternatively, the routines shown in FIG. 4 and FIG. 5 may be conducted simultaneously. That is, characteristics of test systems may be analyzed and stored in accordance with the method shown in FIG. 4 at the same time that one or most test systems are being selected in accordance with the method shown in FIG. 5.

As seen at block 502, the management server receives a description of requirements for a particular test system. Typically, the test system requirements may be associated with a software program to be tested. For example, a software program may require characteristics A, B, C and the test system requirements to test the software program may thus also be, A, B, C. In one embodiment of the invention, a user may communicate the test requirements directly to the management server 105. For example, the user may load the software program onto the management server and the server may analyze the software to determine the test system requirements automatically. Alternatively, the user may manually provide the test system requirements to the management server.

As seen at block 504, the management server 105 may then compare the test system requirements determined at block 502 to the database of systems compiled with the routine of FIG. 4.

If there is no match whatsoever, the server may return to the routine of FIG. 4 and attempt to gather more information about more test systems.

Alternatively, if there is any suitable match, the server may proceed to block 506 and may contact one or more management agents associated with the matching system or systems. Which management agents and how many management agents may be contacted depend on the nature of the test to be run and the test requirements specified at block 502.

Once the management agents have been contacted, as seen at block 508 the server 105 may distribute the test to the appropriate management agents for distribution to the components of the matching test systems. Alternatively, the server may distribute the test directly to the components of the matching test systems. Again, which management agents or system components may receive the test depends on the nature of the test to be run and the test requirements specified at block 502.

In one embodiment of the invention, the matching test system may be an entire system that matches all the requirements of a given test. For example, Software Test Alpha may require a test running on one or more target devices, all of which have the characteristics A, B, C. In the embodiment shown in FIG. 1, the management server 105 may determine that only system 110 is an exact match for the test requirements. The server 105 will therefore distribute the test to management agent 114 or directly to system 110.

Alternatively, the matching test system may comprise one or more matching test systems. For example, Software Test Gamma may require a test running on a target device having the characteristics A, B, C and a target device having the characteristics D, E, F. In the embodiment shown in FIG. 1, the management server may determine that system 110 combined with system 130 will fulfill the test requirements. The server 105 will therefore distribute the test to management agent 114 and management agent 134 or directly to subsystems 110, 130. As the test is running, the management server 105, alone or in conjunction with one or more management agents, may allow communication between the components of the test. Thus, although system 130 may not usually communicate with system 110, when a given test is running, system 130 may be enabled by management server 105 to communicate with the other system involved in the test. In the test described above, the test system used to run the test is a hybrid system including system 110 and 130.

Alternatively, the matching test system may comprise one matching test system for a first component of the test and another matching test system for a second component of the test. For example, Software Test Delta may have a first component Delta-A that requires a system including one or more target devices having the characteristics A, B, C and a second component Delta-B that will further require one or more target devices having the characteristics D, E, F. In the embodiment shown in FIG. 1, the management server may determine that system 110 followed by system 130 will fulfill the test requirements. The server 105 will therefore distribute the test to management agent 114 and management agent 134 or directly to subsystems 110, 130. Alternatively, the server 105 may distribute the first component of the test (Delta-A) to management agent 114 and the second component of the test (Delta-B) to management agent 134. As the test is running, the management server 105, alone or in conjunction with one or more management agents, may allow communication between the components of the test. Thus, management agent 105 may be used to coordinate the components of the test. In the test described above, the test system used to run the test is a hybrid system including system 110 and 130.

Alternatively, the matching test system may be determined using a “fuzzy match” where a potential test system need only meet some criteria to a certain degree. Thus, in one embodiment of the invention, the characteristics described above may also be characterized as “must match” characteristics whereas others are described as “preference to match.” For example, Software Test Omega may require a system that includes one or more target devices, all of which must have the characteristic B and are preferred to have the characteristic A. In the embodiment shown in FIG. 1, the management server may determine that system 110 may be used for the test and, further that system 120 may also be used, even though system 120 does not have characteristic A. The server 105 will therefore distribute the test to management agent 114 and management agent 124 or directly to subsystems 110, 120. As the test is running, the management server 105, alone or in conjunction with one or more management agents, may allow communication between the components of the test. Thus, although subsystem 110 may not usually communicate with subsystem 120, when a given test is running, management server 105 and management agents 114 may enable subsystem 110 to communicate with the other devices involved in the test. In the test described above, the test system used to run the test is a hybrid system comprising system 110 and system 120.

As seen at block 510, the management server 105 may receive status reports from the management agents. For example, the agents for the systems involved in the test may indicate to the management server the devices that are running the test so the test's progress may be tracked. The management server may also provide updates to a management agent in one system involved in a test about another system involved in the test. Thus, in the above, example, management agent 114 would provide a status report on system 110 while management agent 134 would provide a status report on system 130. Meanwhile, management server 105 may update agent 114 on the progress of the test in system 130 and may update agent 134 on the progress of the test in system 110. Thus, the management server enables the systems running the test to be aware of any other systems involved in the test.

As seen at block 512, the management server may check whether the test has been completed. The management server 105 may check the test's progress for example, by checking a given target device, by checking a given system or by checking the software test originally accessed by the management server at 502. If the test is not completed, the management server may continue to provide information when it is requested by test. The server may provide this information by forwarding information to the test from a given target device or from a given system. Alternatively, the server may provide the information and/or instructions from the test to a given target device or a given test system. Typically, the information or instructions from the test may take the form of data or computer program code.

As seen at block 514, if the test is completed, the management server may erase the test from the system. The server 105 may erase the test from one or all of the following: the management server 105 itself, one or more test systems running the test, one or more target devices running the test. In one embodiment of the invention, data records about the test or created as the test was running may be stored for example, in a storage unit on or associated with the management server 105 or in a storage unit associated with the test itself.

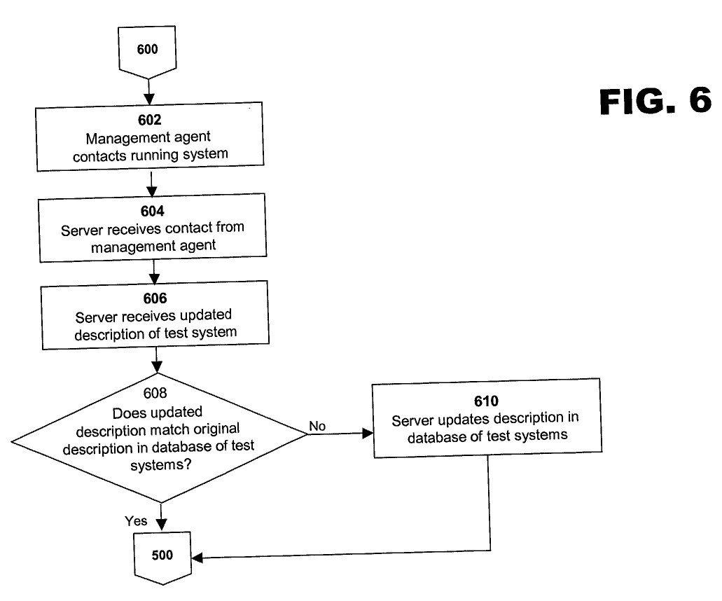

FIG. 6 shows a flow diagram of one embodiment of a method for updating a test system in accordance with the present invention at 400. The test system to be updated using this method may be a system comprising one or more target devices and/or one or more management agents, such as subsystem 110, 120, 130 depicted in FIG. 1 and described above. In one embodiment of the invention, the method of FIG. 6 is administered by a software program or application on or in association with the management server 105.

As seen at block 602, a management agent contacts a system that may be used as a test system. In one embodiment of the invention, the test system is a system that is currently operating or running. In one embodiment of the invention, the test system is running and the management agent begins contact by coming on line, e.g., the management agent is started by a user or the management agent is turned on when one or more components of the running system boot up. For example, in subsystem 110, management agent 114 may be started manually by a user. Alternatively, management agent 114 may be started when one or more components of subsystem 110 are running. In another embodiment of the invention, the system is running, including the management agent. The management agent then begins contact with the server after receiving a command, for example, from a user.

As seen at block 604, the management server receives contact from one or more management agents. For example, in the embodiment shown in FIG. 1, the management server 105 may be contacted by management agent 114, management agent 124, and/or management agent 134. In one embodiment of the invention, the management agent contacts the management server with a description of updated information about the test system with which the agent is associated as described below at block 606.

As seen at block 606, once contact with the management server has been established, the management agent may describe to the management server 105 the updated characteristics of the test system with which the agent is associated. To continue the example given above, management agent 114 may have originally described to the management server 105 the characteristics of system 110 (e.g., “test system 110 has characteristics A, B, C”). The updated description from management agent 114 may describe changed characteristics of system 110 (e.g., “test system 110 now has characteristics D, B, C”). Meanwhile, management agent 124 may describe added characteristics of system 120 (e.g., “test system 120 originally had characteristics D, B, C and now also has characteristic E.”) Management server 105 may also be contacted by management agent 134, which describes removed characteristics of system 130 (e.g. “test system 130 originally had characteristics D, E, F and now has only characteristics D, E.”) These characteristics may include, for example, the operating system running on a given test system, memory resources of the system, hardware resources of the system and software applications running on the system.

Once an agent has contacted the management server and provided the information, the management agent may wait for further communication from the management server 105.

As seen at block 608, the management server may then determine if the updated characteristics of the test system described by a particular management agent have already been entered in a database of systems associated with the management server 105. The database may be the same database as described above or may be any suitable database. For example, as described above, the database of systems may be stored in storage unit 106 as described above.

As seen at block 610, if the updated description of the test system is not entered into the database of systems, the management agent may then update the description of the test system in the database. Thus, over time, the management server may modify a database comprising several test systems, all of which may be available to network 102 for testing distributed software. Some or all of these systems 110, 120, 130 may be fully functioning systems that are equipped to conduct the business of the network 102. Alternatively, some of the systems 110, 120, 130 may be available only for testing purposes.

While the present invention has been described in the context of a fully functioning data processing system, it will be appreciated that the processes described may be distributed in any other suitable context. For example, the processes described may take the form of a computer readable medium of instructions. The present invention applies equally regardless of the type of signal bearing media actually used to carry out the distribution. Examples of computer readable media include recordable-type medium, such as a floppy disk, a hard disk drive, a RAM, CD-ROMs, DVD-ROMS, and transmission-type media, such as digital and analog communications links, wired or wireless communications links using transmission forms such as, for example, radio frequency and light wave transmissions. The computer readable media may take the form of coded formats that are decoded for actual use in a particular data processing system.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of selecting a test system in a distributed network environment, comprising the steps of:
determining, at a management server, a target test system description, the target test system description associated with a software test;
comparing, at the management server, the target test system description to a test system descriptions list;
selecting a test system description from the test system descriptions list that matches the target test system description; and
contacting a selected test system, the selected test system associated with the selected test system description.

2. The method of claim 1 further comprising:
receiving, at the management server, the software test associated with the target test system description.

3. The method of claim 2 further comprising:
forwarding, from the management server, the software test, to the selected test system; and
executing the software test at the selected test system.

4. The method of claim 1 further comprising:
receiving at the management server, a test system description, the test system description associated with a functioning system in the distributed network environment.

5. The method of claim 4 further comprising:
comparing the test system description to the test system descriptions list.

6. The method of claim 4 further comprising:
adding the test system description to the test system descriptions list.

7. The method of claim 4 further comprising:
communicating with the functioning system at a management agent;
determining at least one characteristic of the functioning system at the management agent; and
creating the test system description based on the at least one characteristic.

8. The method of claim 1 wherein the test system descriptions list comprises test system descriptions selected from the group consisting of:
descriptions of fully functioning test systems, descriptions of heterogeneous test systems, descriptions of test systems used to balance a network workload, descriptions of test systems used during specific usage periods, and descriptions of test systems compatible with a particular test.

9. Computer program product in a computer usable medium for selecting a test system in a distributed network environment, comprising:
means for determining, at a management server, a target test system description, the target test system description associated with a software test;
means for comparing, at the management server, the target test system description to a test system descriptions list;
means for selecting a test system description from the test system descriptions list that matches the target test system description; and
means for contacting a selected test system, the selected test system associated with the selected test system description.

10. The product of claim 9 further comprising:
means for receiving, at the management server, the software test associated with the target test system description.

11. The product of claim 10 further comprising:
means for forwarding, from the management server, the software test, to the selected test system; and
means for executing the software test at the selected test system.

12. The product of claim 9 further comprising:
means for receiving at the management server, a test system description, the test system description associated with a functioning system in the distributed network environment.

13. The product of claim 12 further comprising:
means for comparing the test system description to the test system descriptions list.

14. The product of claim 12 further comprising:
means for adding the test system description to the test system descriptions list.

15. The product of claim 12 further comprising:
means for communicating with the functioning system at a management agent;
means for determining at least one characteristic of the functioning system at the management agent; and
means for creating the test system description based on the at least one characteristic.

16. A system for selecting a test system in a distributed network environment, comprising:
means for determining, at a management server, a target test system description, the target test system description associated with a software test;
means for comparing, at the management server, the target test system description to a test system descriptions list;
means for selecting a test system description from the test system descriptions list that matches the target test system description; and
means for contacting a selected test system, the selected test system associated with the selected test system description.

17. The system of claim 16 further comprising:
means for receiving, at the management server, the software test associated with the target test system description.
means for forwarding, from the management server, the software test, to the selected test system; and
means for executing the software test at the selected test system.

18. The system of claim 16 further comprising:
means for receiving at the management server, a test system description, the test system description associated with a functioning system in the distributed network environment.

19. The system of claim 18 further comprising:
means for comparing the test system description to the test system descriptions list.

20. The system of claim 18 further comprising:
means for adding the test system description to the test system descriptions list.

21. The system of claim 18 further comprising:
means for communicating with the functioning system at a management agent;
means for determining at least one characteristic of the functioning system at the management agent; and
means for creating the test system description based on the at least one characteristic.
